(19) United States
(12) Patent Application Publication
(10) Pub. No.: US 2014/0038950 A1
(43) Pub. Date: Feb. 6, 2014

(54) PLANT TREATMENT

(71) Applicant: NORMAN J. HELIE, CHERRY VALLEY, MA (US)

(72) Inventor: NORMAN J. HELIE, CHERRY VALLEY, MA (US)

(21) Appl. No.: 14/020,880

(22) Filed: Sep. 8, 2013

Related U.S. Application Data
(63) Continuation of application No. PCT/US2012/049675, filed on Aug. 5, 2012.
Application No. PCT/US2012/049675 is a continuation of application No. 13/565,719, filed on Aug. 2, 2012.
(60) Provisional application No. 61/698,466, filed on Sep. 7, 2012.
(60) Provisional application No. 61/799,369, filed on Mar. 15, 2013.
(60) Provisional application No. 61/869,748, filed on Aug. 25, 2013.

(51) Int. Cl. A01N 43/653; A01N 43/54; A01N 43/88

(52) U.S. Cl. CPC A01N 43/653; A01N 43/88; A01N 43/54
USPC 514/229.2; 514/269

(57) ABSTRACT

An anti-fungal treatment for trees and bushes. Included are all methods of delivery of active ingredients, including foliar and trunk spraying application, granular soil surface, soil drench, soil injection, and trunk injection. The chemical combination includes a group 3 fungicide like propiconazole, that is, a systemic with curative and protective action, that works via the demethylation of C-14 during ergosterol biosynthesis. The combination also includes a group 11 fungicide like Azoxystrobin, or Fluoxastrobin for which their biochemical mode of action is inhibition of electron transport. The combined efficacy of there two classes of chemicals is reduced spreading of the fungus and increased killing of fungus. It has also been found that these chemicals used individually on trees and bushes, have unexpected benefits.

### CROSS-REFERENCE TO RELATED APPLICATIONS

This application claims the benefit under 35 U.S.C. §119(e) of:

U.S. Provisional Application No. 61/523,773 filed Aug. 15, 2011,
U.S. Provisional Application No. 61/524,619 filed Aug. 17, 2011,
U.S. Provisional Application No. 61/698,466 filed Sep. 7, 2012,
U.S. Provisional Application No. 61/799,369,466 filed Mar. 15, 2013,
U.S. Provisional Application No. 61/869,748 filed Aug. 25, 2013,
U.S. Provisional Application No. 61/869,748 filed Aug. 29, 2013,
U.S. Non-Provisional Application No. 13565719 filed Aug. 2, 2012,
PCT Application No. PCT/US2012/0492675 filed Aug. 5, 2012,
all of which are hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves anti-fungal treatment for trees and shrubs.

### BACKGROUND OF THE INVENTION

A great deal of work has been done to develop effective anti-fungicidal compounds, especially for crops and turf grass.

Strobilurin fungicides. The technical name for the strobilurin class of fungicides is the quinone outside inhibitors (Qol). This group includes active ingredients such as azoxystrobin, fluoxastrobin, pyraclostrobin, and trifloxystrobin. Strobilurin fungicides inhibit the respiration of fungi. In addition, strobilurin fungicides are most effective at inhibiting fungal spores from germinating. They can inhibit mycelial growth of the fungus as well, but inhibiting spore germination is what they do best. Strobilurin fungicides have limited movement (systemicity) in the plant. They can have translaminar movement (across the leaf), but only azoxystrobin and fluoxastrobin move within the xylem of the plant. Strobilurin fungicides tend to accumulate in the cuticle layers of the leaves. Because of their high efficacy in inhibiting spore germination and their tendency to accumulate in the cuticle layers of the leaves, strobilurin fungicides work best when applied preventatively—prior to pathogenic fungi penetrating the leaves and growing throughout the leaf cells.

Triazole fungicides. The technical name of this class of fungicides is the demethylation inhibitors (DMI). This group includes active ingredients such as metconazole, propiconazole, prothioconazole, and tebuconazole. Triazole fungicides inhibit ergosterol biosynthesis in pathogenic fungi. Because spores already contain ergosterol, the triazole fungicides are generally not very effective in preventing spore germination. Triazole fungicides work best by inhibiting fungi's mycelial growth. In general, the triazole fungicides tend to be absorbed and move more quickly within the plant than the strobilurin fungicides. Triazole fungicides move through the xylem of the plant (upward movement only). Because of their ability to inhibit mycelial growth and their movement through the xylem, triazole fungicides may have some postinfection activity on fungi—some people refer to this type of activity as “curative.” It should be noted that this activity actually does not cure anything—it simply means that the fungicide has the ability to inhibit a fungus that already has entered the plant.

“Curative” vs. “preventative” fungicides. In the world of marketing, triazole fungicides seem to have become synonymous with so-called curative fungicide, and strobilurin fungicides with so-called preventative fungicide. The fact is that in some cases, the strobilurin fungicides can have “curative” activity and the triazole fungicides can have “preventative” activity, so it's important not to get too wrapped up in the two categories.

Solo vs. combination active ingredient (a.i.) products. I often get asked if there are advantages to using products with a premix of triazole and strobilurin fungicides over those with one or the other alone. The general advantages of using products with a triazole-strobilurin mixture are these: a broader range of pathogen species may be controlled; fungicides may accumulate and move into different plant tissues; and the risk of selecting fungicide-resistant variants of fungal pathogens may be reduced. These advantages especially hold true when the amounts of fungicide active ingredients (lb a.i./A) in the premix are similar to the amounts when applying the solo products. In other words, how similar is the rate, per acre, of the strobilurin active ingredient in the premix vs. the rate of the same strobilurin fungicide in the solo product?

Comparing amounts of active ingredient among premix products. Other questions that I have received recently deal with the actual amount of strobilurin active ingredient or triazole active ingredient in one premix product vs. another. Even though two particular fungicide active ingredients are in the same fungicide class (for example, azoxystrobin and pyraclostrobin), inherent differences between them do exist. For instance, 1 gram of azoxystrobin may not be equal to 1 gram of pyraclostrobin in the ability to inhibit a fungus. It is thus very difficult to compare two premix products solely on the amount of strobilurin or triazole active ingredient they contain unless their ingredients are identical. A better comparison would be between the amounts of strobilurin and triazole active ingredients in the premix product and the amounts of the same strobilurin and triazole active ingredients that would be applied with the solo products.

Disease control effects vs. physiological fungicide effects. In some cases, foliar fungicides may have effects on plants other than disease control. The strobilurin fungicides, especially, have been researched for their potential physiological effects. Peer-reviewed scientific articles have been published documenting that in greenhouse and laboratory studies, strobilurin fungicides can have physiological effects on plants. These published effects include delayed senescence, altered amounts of plant hormones, increased activity of antioxidative enzymes, and increased activity of nitrate reductase. Although these effects have been documented in greenhouse and laboratory studies, they have not been reported from field research studies. In addition, the link between these potential physiological effects and grain yields has not been reported.

The disease control effects of fungicides have been well documented in field studies, and the consistency of profitability from fungicide applications increases as disease pressure increases. In University of Illinois corn fungicide trials conducted from 2008 to 2010 across several locations in the state, the average yield increase from foliar fungicides in seven environments with low disease pressure was 0.1 bu/A. Conversely, the average yield increase from foliar fungicides in eight environments of moderate to high disease pressure was 15.4 bu/A. These results tell us that fungicides should be applied to crops based on disease risk and scouting observations, not the potential physiological effect that may or may not occur and may or may not affect yield.

In summary, I would note these key conclusions. Foliar fungicide products differ in their active ingredients, but gram-per-gram comparisons of active ingredients are not always appropriate. Specific ingredients may have inherent differences even if they are in the same fungicide class.

There are potential advantages to using products that contain fungicide active ingredients from two different fungicide classes.

Achieving consistent economic benefits with fungicides is more likely when applications are made based on disease risk and scouting observations. This is a more profitable approach than applying a fungicide in hopes of achieving a yield increase based on potential physiological (non-disease control) effects on the plant.

Strobilurins are one of the most important classes of agricultural fungicides. The first strobilurin fungicides in this family were isolated from wood-rotting mushroom fungi, including one called Strobilurus tenacellus. The name strobilurin was coined for this chemical family of fungicides in recognition of the source of the first compounds of this type.

The discovery of the strobilurin fungicides was inspired by a group of natural b-methoxyacrylates, the simplest of which are strobilurin A and oudemansin A. The natural products were found to be unsuitable as agricultural fungicides, but a knowledge of their structures and properties provided a useful starting point for independent programs of research within ICI (now part of Syngenta) and BASF. When ICI and BASF published their first patent applications, other companies also recognized the importance of this class of chemistry and began their own research in the area. ICI and BASF announced the first development strobilurins, azoxystrobin, and kresoximmethyl, respectively, in 1992. These products were sold for the first time in 1996, for the control of diseases in temperate cereals. Since that time, other products have been announced, namely trifloxystrobin from Novartis (this product was recently sold to Bayer), metominostrobin from Shionogi, pyraclostrobin from BASF, and picoxystrobin from Syngenta. azoxystrobin and picoxystrobin retain the methyl b-methoxyacrylate group of the natural fungicides, while the others contain modified toxophores. More recently, DuPont and Aventis, respectively, have discovered famoxadone and fenamidone, fungicides which are not structurally-related to the strobilurins, but which have the same mode of action.

The strobilurins are an outstanding new class of fungicides. Registrations have been obtained on a wide range of crops throughout the world, to the point where the strobilurins can now be considered to be one of the most valuable classes of single-site fungicides ever discovered by the agrochemical industry. They have set new standards in disease control and, more importantly for the grower, in the delivery of improved yields and quality. Indeed, the success of the strobilurins in the fungicide market simply reflects the benefits that they bring to those producing the crop.

Mode of action: The strobilurins act by inhibiting mitochondrial respiration in fungi. They bind at the Qo-centre on cytochrome b and block electron transfer between cytochrome b and cytochrome c1. This disrupts the energy cycle within the fungus by halting the production of ATP. As a family, the strobilurin fungicides give high levels of activity against a wide range of crop diseases. Target diseases for nearly all strobilurin fungicides include downy mildew, rust, powdery mildew and many leaf spots (Alternaria, Cercospora, Myrothecium and Sphaceloma, which causes scab on poinsettia). Indeed, one of the key reasons for the outstanding commercial success of azoxystrobin is that it gives control of fungi from all four classes of plant pathogens, namely the Ascomycetes, Basidiomycetes, Deuteromycetes and Oomycetes. Therefore, azoxystrobin gives control of combinations of pathogens which was previously only possible through the mixture of two or more fungicides, e.g. downy and powdery mildew of grapevines. However, not all strobilurins are broad spectrum fungicides used on a wide range of crops. For example, metominostrobin from Shionogi has been developed for use exclusively on rice. Similarly, other strobilurins do not offer high level control of all four classes of fungal plant pathogens; kresoxim-methyl and trifloxystrobin are both relatively weak against rust diseases and downy mildews. Of the recently announced strobilurins, pyraclostrobin from BASF is a broad-spectrum strobilurin for use on a wide range of crops, whereas Syngenta's picoxystrobin is a specialist cereal fungicide.

Resistance: Experience with the strobilurin fungicides worldwide indicates there is a high risk of development of resistant pathogen subpopulations. Worldwide, resistance has been reported in an increasing number of pathogens of field crops, fruit, vegetable, and nut crops, ornamentals and turf grass.

There are two general types of fungicide resistance: quantitative and qualitative. With quantitative resistance, resistant strains are somewhat less sensitive to the fungicide as compared to the wild type, but they often can still be controlled with higher rates and/or more frequent applications (within labeled limits, of course). A good example of this type of resistance is that observed with strains resistant to the DMI (demethylation-inhibitor) fungicides, such as propiconazole or triadimefon. With qualitative resistance, the resistant strain is vastly less sensitive to the active ingredient, and is no longer controlled at labeled field rates. The effect on disease control is the same as if one were spraying water on the crop instead of a fungicide. A good example of this type of resistance is that observed with the benzimidazole fungicides, such as benomyl or thiophanate methyl. Natural occurrences of resistance to the strobilurin fungicides indicate that most cases of control failure are due to resistance of the qualitative type, but that instances of quantitative resistance to certain strobilurin fungicides have also been recorded.

Fungicides that share a common biochemical mode of action for poisoning the fungus are thought to be in the same “fungicide family”. When different fungicidal products share a common mode of action, the fungus does not distinguish between the fungicides, even if the chemical structure of the active ingredients is different and the fungicides are produced by different manufacturers. Biochemically, the fungus sees them all as the same active ingredient.

When a fungus is resistant to one fungicide in a chemical family, it is usually resistant to all fungicides in that family. This is called cross resistance. In many situations, fungal strains resistant to strobilurin fungicides exhibit cross-resistance to other strobilurin fungicides. In such cases, efficacy of all strobilurin fungicides may be compromised, even if some of them have never been used on that farm. Cross-resistance only applies within a given chemical family. Therefore, strobilurin-resistant subpopulations can be controlled with other fungicides not in the strobilurin family.

Quilt a “New” Fungicide Option for Small Grain Leaf Diseases, by Tracy Sayler. Quilt™ is a new fungicide available for wheat and barley this growing season, although to be precise, the Syngenta product is actually a combination of two fungicide chemistries the company already has available: Tilt® (propiconazole 11.7%) and Quadris® (azoxystrobin 7.0%) According to Syngenta, the two modes of action in Quilt combine for broader spectrum disease control, providing “curative, protectant and eradicant activity against all stages of fungal pathogens (spore germination, mycelial growth and sporulation).” The company says Quilt protects against some of the most damaging foliar diseases, including Septoria, powdery mildew and rusts. For early season suppression of powdery mildew, leaf blotch, glume blotch, and tan spot, Syngenta advises using a reduced rate of 7 oz/ac. The standard rate, 14 oz/ac, controls Puccinia rusts (leaf, stripe and stem), powdery mildew, leaf blight, Septoria leaf blight and glume blotch, tan spot, Helminthosporium leaf blight, barley scald, barley stripe, net blotch and kernel blight.

Quilt can be applied by ground, air or chemigation. Quilt can be applied up to Feekes 9, but optimum timing is when Quilt is applied as the flag leaf reaches 50 to 70% emergence, according to Syngenta. Marcia McMullen, extension plant pathologist at North Dakota State University, says strobilurin containing fungicides such as Quilt, Quadris, Headline, and Stratego (another combination product, triazole/propiconazole plus trifloxystrobin) have excellent activity against fungal leaf spot diseases such as tan spot and Septoria. McMullen says she is still gathering performance data on Quilt, as last year was the first growing season she has evaluated the product. She tested it in an early-season trial to control tan spot, and another where Tilt and Quilt were compared for leaf spot control when applied at flag leaf.

In the early season study, both were applied at the 4-5 leaf stage to Oxen spring wheat; Tilt was applied at 2 oz and Quilt at 7 oz. Both products performed very similarly in leaf spot disease control and in yield enhancement (4.6 bu over untreated check). In the flag leaf application study, Quilt was applied at the full rate application of 14 fl oz, and it was compared to Tilt, Headline, Folicur and Stratego, all at full label rates for one application. All products performed almost identically in leaf spot disease control and all gave similar yield responses, she says.

University of Minnesota extension plant pathologist Charla Hollingsworth also evaluated Quilt in trials last year near Crookston. She says tests on the spring wheat variety Ingot showed that Quilt (applied at nearly full label 13.68 fl oz at flag leaf), Stratego, and Tilt (full labeled rates) had the same yield advantages over the nontreated treatment, while Headline and Quadris had statistically better yields. She again tested Quilt at 10.26 fl. oz applied at flag leaf, with no statistical yield difference compared to Stratego, Tilt, or Headline, and with Quadris holding a slight statistical yield advantage. The best yield response in 2003 was achieved with a flag leaf application of Quilt at 13.68 fl. oz. without adding a nonionic surfactant (as in the above applications). “Those yield results put Quilt on even footing with Stratego, Tilt, Headline, and Quadris,” she says, adding that the product will be tested again this year.

Emmett Lampert, technical sales support representative with Syngenta, says Tilt® (Syngenta Crop Protection, LLC, P.O. Box 18300, Greensboro, N.C. 27419) is an excellent choice as a tank-mix partner applied early with a broadleaf herbicide for early-season disease control, and later in the season, up to flowering (Feekes 10.5). Quilt® (Syngenta Crop Protection, LLC, P.O. Box 18300, Greensboro, N.C. 27419) is probably a better choice applied at flag leaf, or applied without a tank mix partner. “If you apply 7 oz of Quilt® early in the season, you also have the option of coming back with 4 oz of Tilt® either at flag leaf or post heading,” he says.

Last year, there were reports of some plant injury with certain herbicide/fungicide tank mixes, that may have been weather related. Assessment of Quilt® as a tank mix partner is limited; Lampert says further evaluation of the product with different herbicide combinations will be completed this growing season. “So for now if you want to tank mix with a broadleaf herbicide such as Bronate, we recommend growers use Tilt®,” he says.

McMullen adds that when fungicides are tank mixed with herbicides, an additional adjuvant for the fungicide generally is not recommended. The herbicides often have their own adjuvant, and additional ones could cause crop burning.

Quadris® is a strobilurin fungicide that controls a broad spectrum of yield-robbing diseases including blights, mildews and leaf spots. It is relied upon to guard soybean plants from damaging pests and has protected a variety of crops for more than ten years, making it the most widely-used fungicide currently on the market. Quadris goes beyond plant health to maximize Plant Performance™ based on three principles: xylem mobility, broad-spectrum disease control, and physiological plant responses. Quadris not only delivers growers excellent disease protection, but also the ultimate in plant performance, leading to higher yields and better quality soybeans at harvest time.

Higher plant performance through systemic activity gives Quadris a unique advantage. The Quadris X-Factor™ refers to the fungicide's xylem mobile systemic activity, meaning the fungicide moves through the plant with the flow of the water transport system. This allows for even product distribution within the plant under a wide variety of application methods. Quadris also has a proven track record of enhancing plant performance by increasing yields an average of 5.5 bu/A. Through the years, Quadris has proven itself to boost soybean yields in more than 1000 research trials and on millions of U.S. commercial soybean acres.

Quadris improves bean quality by promoting seed uniformity and size. Soybean plants treated with Quadris stay greener longer, increasing their growing time and leading to larger beans and fuller pods.

Quadris Features: Maximizes plant performance and boosts yields in field studies an average of 5.5 bu/A, improving your bottom line. The Quadris X-Factor provides complete protection throughout the plant through excellent xylem mobile systemic activity. Provides control of a wide spectrum of fungal diseases. Impacts plant physiology to enhance green leaf area providing a more lush and green canopy and increasing plant tolerance to water stress for better harvests.

Offers application flexibility and long-lasting residual disease control.

Diseases Quadris is Active Against: Aerial blight (Rhizoctonia solani), Rust (Phakopsora spp.), Anthracnose (Colletotrichum truncatum), Alternaria leaf spot (Alternaria spp.), Brown spot (Septoria glycines), Cercospora blight and leaf spot (Cercospora kikuchii), Frogeye leafspot (Cercospora sojina), Pod and Stem blight (Diaporthe phaseolorum), Southern blight (Sclerotium rolfsii), Rhizoctonia solani (Rhizoctonia solani), Plant Performance™ and Quadris X Factor™ are trademarks of a Syngenta Group Company.

However, these treatments and their mode of application have not been optimized for treatment of trees and bushes.

These and other difficulties experienced with the prior art devices have been obviated in a novel manner by the present invention.

It is, therefore, an outstanding object of some embodiments of the present invention to provide a system for anti-fungal treatment of trees and bushes.

Another object of some embodiments of the present invention is to provide a system for anti-fungal treatment of trees and bushes that is easy to use.

A further object of some embodiments of present invention is to provide a system for anti-fungal treatment of trees and bushes that is highly effective at curing fungal problems.

It is another object of some embodiments of the present invention is to provide a system for anti-fungal treatment of trees and bushes that is highly effective at preventing fungal infection.

It is a further object of some embodiments of the present invention to provide a system for anti-fungal treatment of trees and bushes, that improves the overall health and appearance of the tree or bush (shrub).

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention is system for anti-fungal treatment of trees and bushes. Included are all methods of delivery of active ingredients, including foliar and trunk spraying application, granular soil surface, soil drench, soil injection, and trunk injection. The chemical combination includes a group 3 fungicide like propiconazole, that is, a systemic with curative and protective action, that works via the demethylation of C-14 during ergosterol biosynthesis. The combination also includes a group 11 fungicide like Azoxystrobin, for which their biochemical mode of action is inhibition of electron transport. The combined efficacy of there two classes of chemicals is reduced spreading of the fungus and increased killing of fungus. It has also been found that the group 11 fungicides. used individually on trees and bushes, have unexpected benefits.

### BRIEF DESCRIPTION OF THE DRAWINGS

The character of the invention, however, may best be understood by reference to one of its structural forms, as illustrated by the accompanying drawings, in which:

FIG. 1 is shows a block diagram of the general features of one embodiment of the present invention.

FIG. 2 shows the macro trunk injection rates for combination of 6-12 ml. of propiconazole MEC 14.3% and 4 to 12 ml. of Azoxastrobin 8.8%.

FIG. 3 shows the macro trunk injection rates for Azoxastrobin 8.8% alone.

FIG. 4 is a diagrammatic representation of system for feeding fungicids, through the open face of a viable stump, to an infected root graft network.

### DETAILED DESCRIPTION OF THE INVENTION

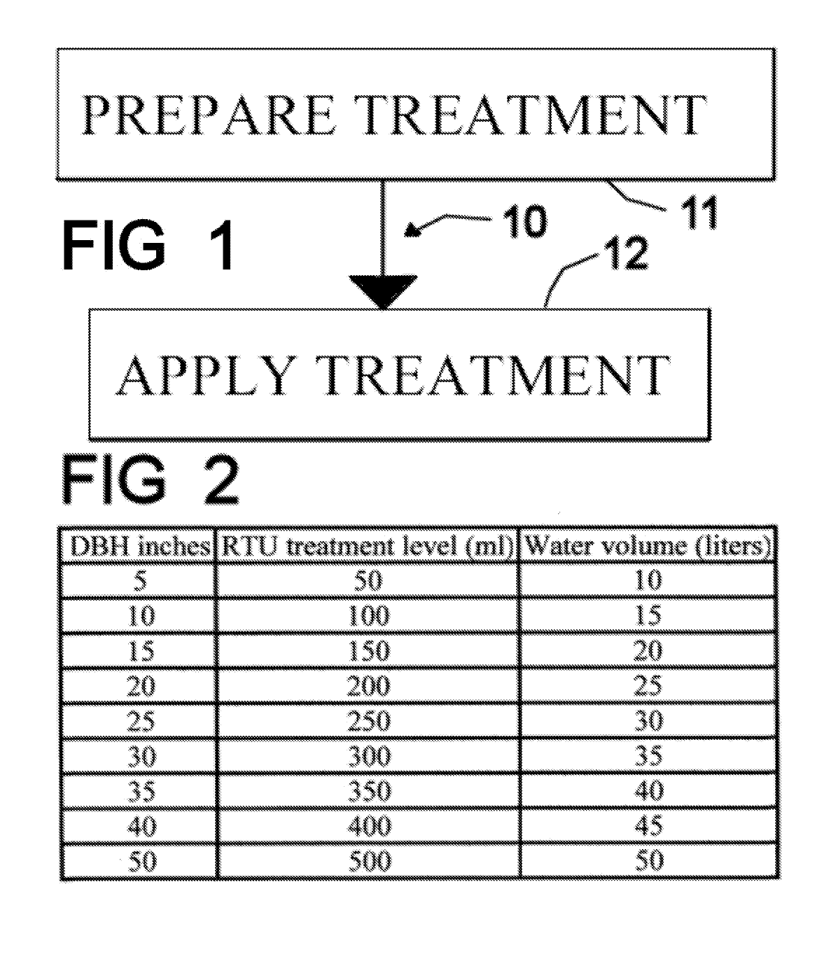

Referring first to FIG. 1 in which the general principles of the present invention are shown, FIG. 1 is a block diagram showing a plant treatment system 10 composed of a chemicals preparation stage 11, followed by a plant treatment stage 12, and embodying the principles of the present invention.

This invention is a chemical combination for the treatment of Dutch Elm Disease and all other vascular wilt diseases (such as but not limited to, oak wilt, verticillium wilt, anthracnose, sap-streak disease, and canker-stain). In addition, this chemical combination efficacy on foliar and/or branch diseases such as anthracnose, rust, cankers, powdery mildew, and dieback should also be covered. All diseases covered by these two individual chemicals should be covered as a chemical combination for all trees and shrubs.

The invention includes all methods of delivery of active ingredients, including foliar and trunk spraying application, granular soil surface, soil drench, soil injection, and micro and macro trunk injection.

The chemical combination includes a group 3 fungicide like propiconazole, that is, a systemic with curative and protective action, that works via the demethylation of C-14 during ergosterol biosynthesis. The combination also includes a group 11 fungicide like Azoxystrobin, for which their biochemical mode of action is inhibition of electron transport. The combined efficacy of there two classes of chemicals is reduced spreading of the fungus and increased killing of fungus. Any and all rates and proportions of each chemical are part on the invention. A product that is analogous to the present invention, called: “Headway” by Syngenta, already exists, but, it is used for turf grass diseases only. This invention is for treating trees and shrubs, and the diseases that affect them.

Dutch Elm Disease treatment: Rates of application and proportions for chemical control of diseases for trees and shrubs. Rates and proportions will vary according to species, timing, and disease pressure.

TREATMENT 1: Foliar and trunk spray rates: 8 to 24 oz. of propiconazole 14.3%, 2 to 4 oz. of Fluoxastrobin 40.3% or 4 to 16 oz. of Azoxystrobin 8.8%. Ready to use (RTU) rates determined by time and disease pressure. Based on 100 gallon dilution rate.

TREATMENT 2: Micro trunk injection rates: 3 to 8 ml. of propiconazole MEC 14.3%, 2 to 7 ml. of Azoxastrobin 8.8%. DBH (diameter at breast height) in inches divided by 2, determines number of capsules (10 ml)(for example, the system developed by the J.J. Mauget Co., Burbank, Calif.) for each tree. A micro-injection wound is one that has a diameter of 3/16 inch or less and penetrates into the xylem ¾ inch or less. I have found that these micro trunk injections are best conducted using the CHEMJET® tree injector manufactured by the CHEMJET® Trading Pty Ltd., 8 Ivedon Street, Banyo QLD Australia 4014. Whenever Propiconazole is injected, some discolorization of the Xylem can occur.

TREATMENT 3: Macro trunk injection rates: RTU injection solution of 6 to 12 ml. of propiconazole MEC 14.3% and 4 to 12 ml. of Azoxastrobin 8.8%. A macro-injection wound (MAI) is defined as a wound that has a diameter ⅜″ or greater and penetrates into the xylem one to several inches.

For TREATMENT 3 tree dosage, see FIG. 2. 10 ml./DBH inch for normal disease. 20 ml./DBH inch for high disease pressure.

TREATMENT 4: Soil drench for trunk line pour: 3 to 24 oz. of propiconazole 14.3%, 1 to 8 oz. of Fluoxastrobin 40.3% or 4 to 16 oz. of Azoxystrobin 8.8%. Estimated RTU solution for drench is a minimum of 5 gallons and a maximum of 30 gallons depending on size of tree.

TREATMENT 5: Soil injection around trunk soil area: 3 to 24 oz. of propiconazole 14.3%, 1 to 8 oz. of Fluoxastrobin 40.3% or 4 to 16 oz. of Azoxystrobin 8.8%. Estimated RTU solution for drench is a minimum of 5 gallons and a maximum of 30 gallons depending on size of tree.

TREATMENT 6: Soil surface granular: 2 to 4 lbs./1,000 sqft. of propiconazole 0.51% to 0.72%, 2 to 4 lbs./1,000 sq ft. of Fluoxastrobin 0.31%. Mix is 50:50 and totals should not exceed 8 lbs./1,000 sq ft. This treatment is especially effective on rosebushes.

Rates of application and proportions for chemical control of diseases for trees and shrubs. Rates and proportions will vary according to species, timing, and disease pressure.

Another aspect of this invention is the use of group 11 fungicides like azoxystrobin (Their biochemical mode of action is inhibition of electron transport) alone, for trunk macro and micro injections. This fungicide is considered to only have local systemic merit. However, if delivered through xylem elements of the tree, its mobility and efficacy is dramatically increased. This trunk micro and macro injection technique of delivering the broad spectrum fungicide azoxystrobin is novel. The product Heritage TL 8.8%® azoxystrobin can be delivered via trunk injection. All type 11 fungicides should be useful for a broad spectrum of disease control. The injection rates will vary according to the size of plant and disease to be treated. For alternative concept of Azoxastrobin alone for micro and macro injection.

TREATMENT 7: Micro trunk injection rates: 5 to 12 ml. of Azoxastrobin 8.8%. DBH in inches divided by 2 determine number of capsules for each tree. Maximum rate per injection site 33 ml.

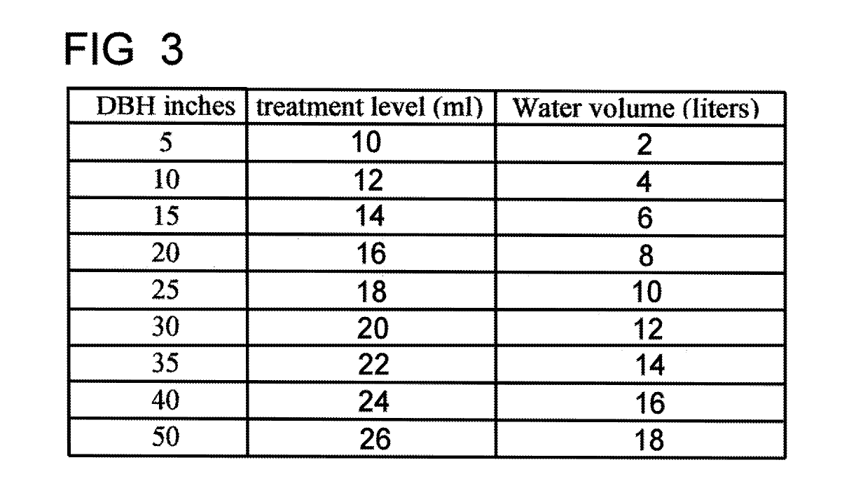

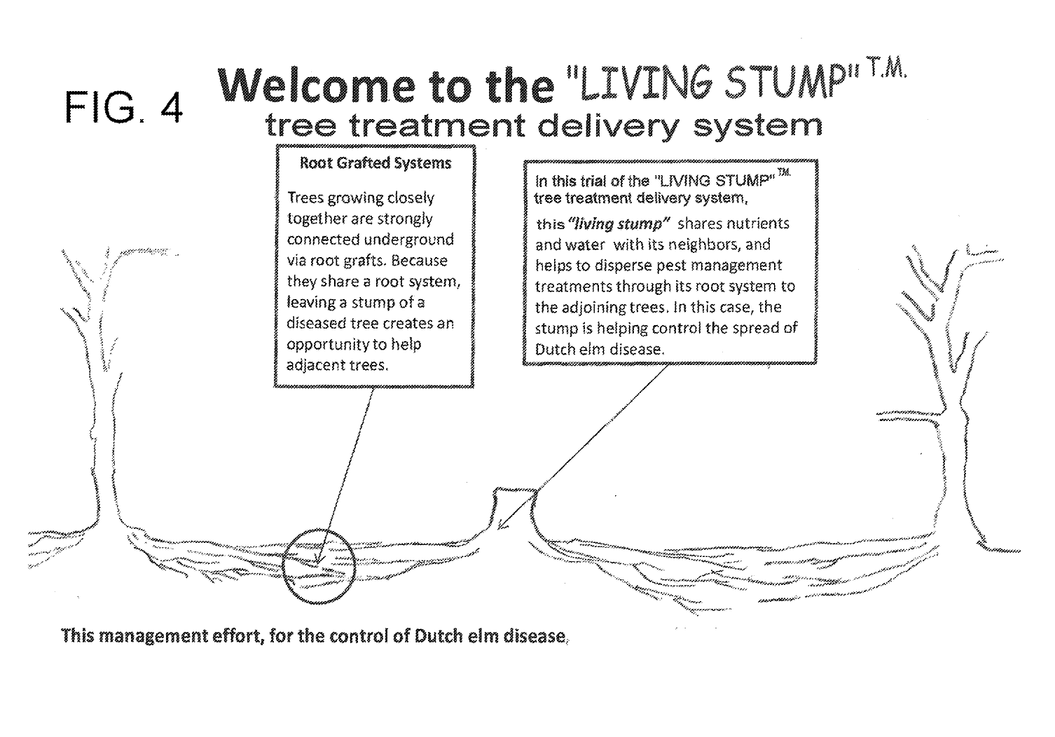

TREATMENT 8: Macro trunk injection rates: Azoxastrobin 8.8%. See FIG. 3.

Proof of how well this invention works in different situations. Many chemicals are effective at controlling Dutch Elm Disease as a preventive treatment. This inventive Dutch Elm Disease treatment is different because it is a combination treatment. An older known chemical that is proven effective against Dutch Elm Disease called propiconazole from the type 3 family of chemistry and a newer generation of fungicides from an entirely different family of chemistry. The strobilurins family is a type 11 fungicides developed from a naturally occurring fungi. The first fungicides in this family were isolated from wood-rotting mushroom fungi, including one called Strobilurus tenacellus. The name strobilurin was coined for this chemical family of fungicides in recognition of the source of the first compounds of this type. These natural fungicides were thought to help the fungus defend itself from competition by microbes present in rotting wood. (Paul Vincelli University of Kentucky Vincelli, P. 2002. Qol (Strobilurin) Fungicides: Benefits and Risks. The Plant Health Instructor. DOI: 10.1094/PHI-1-2002-0809-02. Updated, 2007.

Strobilurrins, when combined with type 3 fungicide such as propiconazole, are more effective at preventing and curating the disease. The power of combination of type 3 and 11 chemical combinations is enhanced efficacy, improved fungal resistance, and an improved plant physiological appearance.

Strobilurin fungicides are most effective at inhibiting fungal spores from germinating. They can inhibit mycelial growth of the fungus as well, but inhibiting spore germination is what they do best (C. Bradley). The vascular wilt Dutch Elm Disease has a disease life cycle that begins with an insect vector called elm bark beetle that carry viable spores to healthy elm trees. These spores germinate in the xylem vessels of elm trees early in the growing season. This is the best time to use this fungicide. Application at the same time or shortly after the emergence of elm bark beetles is highly advised. The strobilurin fungicides such as azoxystrobin and fluoxastrobin are xylem mobile. And they will accumulate in the highest part of the tree where the beetle feeds and causes an infection. Strobilurins also persist for months. This product alone is capable of preventing Dutch Elm Disease. However, when combined with Triazole fungicides with its strengths of greater xylem mobility and greater inhibition of mycelial growth these two chemicals are a powerhouse to combat Dutch Elm Disease. It is well documented that Strobilurins have great broad spectrum control of the Ascomycetes and Deuteromycetes mitosporic fungi. Therefore, I decided to try to combine it with a member of the triazole family of chemicals for Dutch Elm Disease management.

Triazole fungicides inhibit ergosterol biosynthesis in pathogenic fungi. Because spores already contain ergosterol, the triazole fungicides are generally not very effective in preventing spore germination. Triazole fungicides work best by inhibiting fungi's mycelial growth. In general, the triazole fungicides tend to be absorbed and move more quickly within the plant than the strobilurin fungicides. Nevertheless, the triazole fungicides' strengths of greater xylem mobility and greater inhibition of mycelial growth, than strobilurin fungicides have, make this chemical combination a synergistic powerhouse to combat Dutch Elm Disease. When combined, the efficacy of using these products for the control of Dutch Elm Disease is better than using either chemical independently.

Official independent or collegiate research is not available on this topic at this time. My personal field experience shows promising results, but much more work is needed.

Evidence of how far you have to stray from my preferred formulation and application plan before the invention stops being useful (in other words, what are the boundaries of this invention). Not all strobilurins have xylem mobility only azoxystrobin and fluoxastrobin show this ability. The azoxystrobin is slightly more xylem mobile than fluoxastrobin. In drench experiments on flowering dogwoods, the azoxystrobin gave excellent season long control with many of the common dogwood diseases faster than the fluoxastrobin (personal experience).

This fungicides strength is its inhibition of spore germination and is most useful at the beginning of the season. It is not as strong when used later in the season. The strobilurins are both preventative and curative, but its real strength is prevention. If Dutch Elm Disease is moving fast in the tree and the infection is more than 20% of the tree, it is better to remove the diseased tree. Mild or slight infections can be treated.

It is also not advised treatment for every disease. It may have an antagonistic affect with certain bleeding canker diseases such as Phytophthora cactorum and Cytospora kunzei. More research and trial field experience is necessary to confirm this possible treatment antagonism. One plausible explanation is that these diseases have various states and/or stages and these conditions are aggravated by the timing of application of the fungicide combination.

The strobilurins can not be used on apple (Malus domestica) species. All contact with these trees should be avoided. Even the residue in the tank can have phytotoxic effects on these plants. Rinse and wash sprayer thoroughly after each application to avoid this problem. Also, the strobilurins cannot be used on Crabapple-flame variety (Malus spp.) Crabapple-Brandywine variety (Malus spp.), Crabapple, Novamac variety (Malus spp.), Cherry, flowering-Yoshina variety (Prunus yedoensis) and privet (Ligustrun spp.).

For direct trunk injections, the azoxystrobin fungicide is compatible with the physiology of the plants. It will uniformly move into all xylem vessels without phytotoxicity. Other formulations such as fluoxastrobin are not advised for direct trunk injections.

Both azoxystrobin and fluoxastrobin can be applied as a soil drenched around the trunk of a tree, not near ground water, pond, or stream. All the directions of past and current labels for these fungicides must be followed.

Another downside of the type 11 fungicide is expense. Strobilurins cost more money than triazole fungicides.

How valuable is this invention as a business product. The value of the type 3 and 11 fungicide combination for vascular wilt diseases like Dutch Elm Disease speaks for itself. No other chemical combinations exist in the market place today for vascular wilts. The strength of triazole fungicide's inhibition of mycelial growth and the strobilurins inhibition to fungal spore germination and mycelial growth make this product a very useful tool to manage the spread of many vascular wilt diseases. And especially since we know they have sufficient xylem mobility with natural water movement.

Another benefit of the chemical combinations of the present invention are that they are more resistant and superior than a single chemical when one wants to avoid the ability of a fungus to become resistant to the fungicide treatment. In addition, it also aids in enhanced fungal cross resistance to an entire family of chemistry. This saves and extends the efficacy of the triazole fungicides like propiconazole. This effective fungicide for vascular wilt disease should be preserved. This chemical combination will enhance the efficacy and preserve its future use.

The salvation of the efficacy of the triazoles like propiconazole can also be enhanced with the use of strobilurins alone as an alternate treatment. And vice versa the triazoles can be used as well. Treatment plans can go as follows: (1) Initial combination type 3 and 11 fungicide, (2) alternate1, triazole fungicide type 3 alone, (3) alternate 2, strobilurins fungicide type 11 alone, and (4) alternate1, triazole fungicide type 3 alone. After this full 8 year cycle it can start over again. This would be determined by the applicator's monitoring of the disease pressure. Successive applications of any of the same single fungicides from year to year should be avoided but, the combination treatment is advised during years of strong disease pressure. The use of type 11 combined with type 3 and type 11 independently is another great tool for the management of a broad spectrum of diseases on many trees and shrubs. In addition, the unexplained improved health of the plant from the use of strobilurins in the xylem is also beneficial.

Why is this product valuable? The efficacy by using combination fungicides is enhanced when combating difficult to control diseases. Decreased spore germination and stronger inhibition mycelial growth for a broad spectrum of diseases. Strobilurins are considered low risk fungicide because of their site specific action. Inhibits Dutch elm disease spore germination at a perfect time in small branches when vector insects are feeding. Reduced fungicidal resistance and reduced cross resistance to both chemistry families. This product will preserve the efficacy of type 3 Triazoles fungicides and vice versa type 11 will also be protected. Good xylem mobility to control vascular wilts, branches, and foliar diseases systemically. An (unexplained) physiological overall improved plant appearance.

Used singly or combined, they are a great contribution to a tree disease management plan. Strobilurins are labeled for soil applications. This method of application can minimize wounding the tree from direct trunk injections. Propiconazole has great potential for soil application but, is not labeled for this method.

I have found that my combination group 11 and group 3 fungicides treatment works best if it is varied from spring to fall. The group 11 fungicide is a larger percentage of the treatment combination in the spring, whereas the group 3 fungicide is the larger percentage during the rest of the growing year. I have found this variation in the composition of the treatment brings about the healthiest trees and bushes. My theory is that many trees and bushes suffer from various fungus-based diseases that are seasonal, for example that are dormant during the winter months. In the spring, the fungus spores began to germinate and then they began to become active and damage the tree or bush over the spring summer and fall. The spore germination process is most active in the spring, but becomes less active through the season. Thus, the group 11 fungicide which is believed to interfere with the germination of the spores is the dominant active ingredients in the spring when the spore germination is most active. The group 3 active ingredient, which is believed to interfere with the growth and activity of the fungus essentially inactivates any spores that managed to germinate in the presence of the group 11 fungicide. As the activity of germination slows down, the number of surviving and active fungus increases, the increase in the percentage of group 3 fungicide is more necessary for treating that situation.

For example, the spores responsible for the Dutch Elm Disease is spread by the bark beetle, which becomes active at about 70° F., which typically occurs about May 15. Thus, by treating the tree with the novel combination of this invention about a week or two before the temperature reaches 70° F., the newly deposited spores are discouraged from germinating by the presence of the group 11 fungicide and, those spores that do germinate, are immediately attacked by the group 3 fungicide. As the season proceeds, the germination, and the need for group 11 fungicides lessens.

One of the surprising aspect of the treatment of trees and bushes with both the combination and individual group 11 fungicide, is that the trees and bushes tend to exhibit an improvement in health, vitality, and growth that cannot be easily explained by simply the suppression of fungicidal activity. My present hypothesis is that these fungicides appear to stimulate growth hormones in the tree if applied in a manner described herein. Thus, I find that using these fungicidal treatments actually cause improvements in health of even seemingly-fungus-free trees and bushes.

One of the observations that somewhat supports the explanation for the improved health of the trees and bushes, is that the injection bores that are drilled into the bark of a tree in order to inject the fungicides into the xylem of the tree, appear to heal much more quickly and more completely, when the present combination or single fungicide is injected, than would ordinarily be the case for other chemicals that are injected. Healed trunk injection sites appear normal and free you from phytotoxic damage, even when the fungicide is a applied in non-dilute strength. This rapid healing of the injection sites allows the applicator greater freedom to select application sites up to the bole (trunk) of the tree. Normally, all of the injection sites must be located at the root flare. Furthermore, the healing that does occur appears to result in a much healthier looking injection site; in some cases, looking as if no injection had been made. In the case of ornamental trees and bushes, of course, this can be a significant benefit.

One of the aspects of all this remarkable injection pointed healing process is that the healed wound is so visually identical to the surrounding tree that the discoloring effect of the group 3 fungicide's becomes much more apparent. Therefore, in certain ornamental situations, it is preferable to use the group 11 fungicide without the group 3 fungicide, when the health of the tree allows.

Because this invention relies on the xylem mobility of the fungicide and combination fungicide formulas, it is strongly advised that the trees or shrubs are provided with significant watering prior to application of the fungicide in order to expedite a rapid uniform distribution of the active ingredients throughout the tree or shrub, and a rapid in uniform fungicidal response.

120812 ADDITIONAL INSIGHTS INTO USE OF FUNGICIDES TO COMBAT ROOT GRAFT INFECTION IN TREES.

Research on root graft infections, and why is my combination fungicide product is so valuable?

The efficacy by using combination fungicides is enhanced when combating difficult to control diseases.

Decreased spore germination and stronger inhibition mycelial growth for a broad spectrum of diseases.

Strobilurins are low risk fungicide because of their site specific action.

Inhibits Dutch elm disease spore germination at a perfect time in small branches when vector insects are feeding.

Inhibits rapid and large-scale colonization of vascular wilts by inhibiting spore germination.

Reduced fungicidal resistance and reduced cross resistance to both chemistry families.

This product will preserve the efficacy of type 3 Triazoles fungicides and vice versa type 11 will also be protected.

Excellent xylem mobility to control vascular wilts, branches, and foliar diseases systemically.

An unexplained physiological overall improved plant appearance, that appears to be the result of reduced fungus load, that in turn increases production of amylase. The increased amylase causes increased conversion of carbohydrates to sugars. The reduction of the carbohydrates, on which the fungus feed, further suppresses the fungus. The increase in sugar energizes the tree for health growth and appearance.

Used singly or combined they are a great contribution to a tree disease management plan.

Strobilurins are labeled for soil applications. This method of application can minimize wounding the tree from direct trunk injections.

Propiconazole has great potential for soil application but, is not labeled for this method.

Strobilurins have excellent uptake time when injected into xylem tissue. Three times faster than propiconazole alone. This means less labor in injection time.

The discoloration of xylem tissue is normal and doesn't discolor xylem elements.

Injection site wound closure is faster with strobilurins than with propiconazole.

This disease is capable of producing spores from mycelial forms and distributing the spores through the xylem tissue to new areas in the tree. This causes the appearance of a beetle infection but, it is a root graft or trunk infection. This patent idea will proactively reduce spore germination and the further spreading of infections throughout the tree.

Invasion: Vascular wilt fungi invade xylem vessels internally, but they are usually confined to a few vessels in the roots, the stem, or the top of the infected plants: only in the final stages of the disease do they invade most or all xylem vessels of the plant. The older mycelium can degenerate and disappears and only the younger mycelium survives in actively growing plant tissue.

Growth and reproduction of the pathogen: Individual fungi invade and infect tissue by growing into them from one point of inoculation. The pathogen grows into larger areas and continue to grow and branch out within the infected host indefinitely so that the same pathogen individual spreads into more and more plant tissues until the spread is stopped or the plant is dead. In some fungal infections, however while younger hyphae continue to grow into new healthy tissues, older ones in the already infected areas die out and disappear so that a diseased plant may have several points where separate units of the mycelium are active. Also, fungi causing vascular wilts often invade plants by producing and releasing spores within the vessels, and as the spores are carried in the sap stream they invade vessels far away from the mycelium, germinate there, and produce a mycelium, which invades more vessels. Vascular wilts produce spores within the host tissues, and these spores are not released outward until the host dies and disintegrates. Agrios G. N. 2005. Plant Pathology Fifth Ed. Elsevier Academic Press. Pp. 91-94 (This concept is important when to remember when dealing with root graft infections. Stumps of infected trees should remain as “living stumps” to manage disease spread and help deliver systemic fungicides through the root system.) (Personal experience by inventor Helie N. J., 2012).

With root graft infections the fungus reaches the large xylem vessels in the woody root tissue, it produces Sporothrix-type spores, which are carried up by the sap stream. These spores reproduce by yeast-like budding, germinate and start new infections. The extent of symptoms in the crown is correlated with the extent of vascular root graft invasion. (These symptoms are exacerbated by the removal of a tree and or its stump. The removal of the tree reduces sugar content in the roots. The starch concentration levels increase and provide excellent medium for reproduction structures such as Sporothrix-type spores. These spores are carried to the next plant by the transpiration of water movement through the grafted root system. This movement of spores can be stopped by the application of systemic fungicides applied to both adjacent trees, called donor trees, and the “living stump”. The stump should also be treated with insecticides to manage elm bark beetle invasions.) (Personal recommendation by inventor Helie, N. J., 2012) Agrios G. N. 2005. Plant Pathology Fifth Ed. Elsevier Academic Press. Pp. 91-94 and 531-532.

120818 Strategies to combat wilt disease root graft infections.

Don't Plant Monocultures

Increase distance between same species of elm, oak, or any other tree for that matter.

Don't remove stumps in root graft zones right away. Instead allow these stumps to become “living stumps”. Treat them with insecticide to control bark beetles and allow stumps to be used for fungicide drench treatments. This will allow systemic fungicides to be more effective through the entire root system. We should also allow these stumps to sprout and grow until they are no longer needed to deliver chemicals to the roots.

Furthermore, the removal of stumps that have strong root graft unions advances the disease to the next tree or trees. When an infected tree is removed and the stump is ground the remaining infected root system is still connected. The water potential gradients that the stump provided no longer exist. The water potential gradient moves to the remaining trees. This strong moisture gradient is then followed by the disease spores and mycelium to the next tree.

Don't trunk inject fungicides into xylem elements because it doesn't work with root graft infections. The xylem tissue primary movement is up the tree. Very little movement in the xylem moves down into the root system. The timing of fungicide drench application will direct fungicides through the root system. This is the basis for my research on biotic root stress treatments. The treatments are oriented around the growth and development of roots. The roots of trees are actively growing in early Spring before leaf development and when soil temperatures reach 40 to 50 degrees Fahrenheit and when leaves begin to turn color in the fall. These are the best times to apply fungicides for diseases in the root system. The forestry industry uses this same principle to deliver herbicides to unwanted tree species in the forest. The success of these herbicide treatments is timing. Likewise, we should employ this technique with fungicides to combat Dutch Elm Disease (DED) and other vascular wilts such as oak wilt.

In summary, the rapid removal of stumps that have root grafted infections advances the disease to the next tree. We should rapidly remove diseased trees, branches, and stumps if no root graft infections exist. We should treat root graft infected stumps as “living stumps”. The maintenance of this stump will allow us to deliver fungicides through the root system. The beetles on these stumps will be managed by insecticides and therefore, be no threat to remaining elm trees.

120828 Cut Stump Treatment (from Round-Up Herbicide Label)

Woody vegetation may be controlled by treating freshly cut stumps and re-sprouts with this product. Apply this product using suitable equipment (added by N.H. 2 inch paint roller and paint cup) to ensure coverage of the entire cambium. Cut vegetation close to root surface. Apply a 50 to 100 percent solution of this product to the freshly cut surface immediately after cutting Delays in application may result in reduced performance. For best results applications should be made during periods of active growth and full leaf expansion.

In like manner, use type 11 azoxystrobin fungicides in full strength with a 2 inch paint roller and paint pail. Apply over entire sap wood and cambium layer for optimum backlash. Backlash is the movement of chemicals usually herbicides applied to stumps or trees to adjoining root grafted trees. Follow-up ten minutes later with the same roller treatment of type 3 propiconazole fungicide.

After a two week period, seal the cambium layer and sapwood to prevent drying out with grafting wax. Reapply grafting wax when necessary throughout the entire growing season and during the winter months. At the same time allow no insects especially elm bark beetles to use stump as habitat. This can be done by applying residual insecticide over entire stump and root flares. (Anti-transpirants can also be used to prevent drying over the cut surface.)

During spring and fall root growth seasons apply fungicides as a drench around and on the entire stump and root fare. Drenching rates should be 50% of the amount used for the adjacent root grafted trees. The stumps should be done first and then the adjacent root grafted trees.

Alternative Care for “Living Stumps”

Applying pressure at specified bark surface for a time will initiate callus formation. This can be done by using a wide loading ratcheting strap and blocks of wood where needed. Pressure will increase callus wound wood formation in the cambium area.

The use of propagation techniques like air-layering. Apply rooting powder for difficult rooting plants over the cambium as a powder. Apply moist sphagnum peat moss in handfuls all around the sapwood and cambium layer. Install clear plastic over peat moss by stapling the plastic to the heartwood and the outer bark. Remove this material when callus formation begins. Keeping the stump moist like a whole tree will improve callus formation.

20829 Additional updates and benefits from this patent.

No label presently addresses the problems of diseases such as Botryosphaeria in trees and shrubs.

This product is labeled for Botryosphaeria on Crops with Quilt Xcel fungicide by Sygenta. Note: field experience shows control of the disease on elm and magnolia trees treated this spring (Helie, N., 2012. Personal experience). Furthermore, disease like downy mildew, Phythium and phythoptera that are not on other fungicides labels are on the type11 fungicide labels.

Amylase production is the end result of the gibberellin acid pathway. The use of type 11 fungicide like azoxystrobin causes delay senescence and increased shoot growth when used early in the growing season (Helie, N., 2012. Personal experience). This could explain the overall improvement in plant growth and the reduction in disease colonization. More research is needed here. More gibberellins mean more amylase production. Gibberellins are a growth hormone responsible for cell enlargement and elongation.

For trees or groups of trees growing with sufficient lawn surface area in park-like settings, it is advised to apply granular fungicides following a specified vertical coring operation (lawn aeration). This will provide a more thorough chemotherapeutic treatment. Smaller adsorption roots will uptake and translocate fungicides through entire vascular systems of roots, shoots, (trunk and branches) and leaves. Both type 3 and 11 fungicides come in granular/liquid formulations for turf-grass management. Because of the increased rooting in the root zone of trees it is advised to use the highest label rate when root growth of trees is most active.

The soil coring should be vertical not drum style with a minimum of 2 inches deep but, no deeper than 3 inches. Twenty holes (¾ inch to 1 inch wide) per square foot are strongly advised for optimum root zone application.

Operations can be followed by routine lawn over-seeding and fertilization. The benefits are numerous and include diseases affecting the root systems due to poor soil conditions. Healthier trees mean less disease and insect infections. This management approach is really convenient because it is just one more step and it is easily applied during lawn maintenance applications.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. An anti-fungal treatment for trees and bushes, comprising the steps of:
a. forming a treatment product that includes:
i. a group 3 fungicide, that is, a systemic with curative and protective action, and that works via the demethylation of C-14 during ergosterol biosynthesis, and
ii. a group 11 fungicide, for which their biochemical mode of action is inhibition of electron transport, and
b. applying the treatment product to a tree or bush at a dosage sufficient to reduce spreading of the fungus and increase killing of fungus.

2. An anti-fungal treatment as recited in claim 1, wherein the group 3 fungicide is Propiconazole.

3. An anti-fungal treatment as recited in claim 1, wherein the group 11 fungicide is Azoxystrobin.

4. An anti-fungal treatment as recited in claim 1, wherein the group 11 fungicide is Fluoxastrobin.

5. An anti-fungal treatment as recited in claim 1, wherein the group 11 fungicide is a combination of Azoxystrobin and Fluoxastrobin.

6. An anti-fungal treatment as recited in claim 1, wherein the group 3 fungicide is Propiconazole, and wherein the group 11 fungicide is Azoxystrobin.

7. An anti-fungal treatment as recited in claim 1, wherein the group 3 fungicide is aPropiconazole, and wherein the group 11 fungicide is Fluoxastrobin

8. An anti-fungal treatment as recited in claim 1, wherein the group 3 fungicide is Propiconazole, and wherein the group 11 fungicide is a combination of Azoxystrobin and Fluoxastrobin.

9. An anti-fungal treatment for trees and bushes, comprising the steps of:
a. forming a treatment product that includes a group 11 fungicide, for which their biochemical mode of action is inhibition of electron transport, and
b. applying the treatment product to a tree or bush at a dosage sufficient to reduce spreading of the fungus and increase killing of fungus.

10. An anti-fungal treatment as recited in claim 5, wherein the group 11 fungicide is Azoxystrobin.

11. An anti-fungal treatment as recited in claim 5, wherein the group 11 fungicide is Fluoxastrobin.

12. An anti-fungal treatment as recited in claim 5, wherein the group 11 fungicide is a combination of Azoxystrobin and Fluoxastrobin.

13. An anti-fungal treatment wherein the anti-fungal is delivered to the roots.

14. An anti-fungal treatment as recited in claim 13, wherein the anti-fungal is delivered to the roots in a root graft network.

15. An anti-fungal treatment as recited in claim 13, wherein the anti-fungal is delivered through the soil to the roots.

16. An anti-fungal treatment as recited in claim 13, wherein the anti-fungal is delivered through the open surface of a viable stump to the roots in a root graft network.

17. An anti-fungal treatment as recited in claim 13, wherein the anti-fungal is delivered to the roots, and wherein the ant-fungal is a combination of Azoxystrobin and Fluoxastrobin.

18. An anti-fungal treatment as recited in claim 13, wherein the anti-fungal is delivered through the open surface of a viable stump to the roots in a root graft network, and wherein the ant-fungal is a combination of Azoxystrobin and Fluoxastrobin.
